(19) United States
(12) Patent Application Publication
(10) Pub. No.: US 2021/0212270 A1
(43) Pub. Date: Jul. 15, 2021

(54) INTEGRATED MOBILE AQUAPONIC SYSTEM

(71) Applicant: DAVID ELLIOTT BOOKER - OGUNDE, BROOKLYN, NY (US)

(72) Inventor: DAVID ELLIOTT BOOKER - OGUNDE, BROOKLYN, NY (US)

(21) Appl. No.: 16/505,745

(22) Filed: Jul. 9, 2019

(51) Int. Cl. A01G 9/02

(52) U.S. Cl. CPC A01G 9/028; A01G 9/247

(57) ABSTRACT

A mobile, semi-automated, multilayered aquaponic appliance for the transport and cultivation of plants, aquatic animals, farm foul and bees. The multi-layered aquaponic appliance utilizes vertical orientation to increase product yield and can be deployed indoors or outdoors. The appliance decreases reliance on municipal resources by generating its own water from an atmospheric condenser, collecting rainwater and harnessing photovoltaic technology that stores energy generated from the sun. The mobile capability of the appliance, when used in plurality, reduces the amount of space used therefore maximizing collective production for commercial applications. The appliance can be assembled and disassembled which allows it to be stored, operated and transported in a variety of spaces. The appliance incorporates some of the design elements of the traditional greenhouse by utilizing porous, translucent cover panels that serve as seedling propagation surfaces and a means of ventilation for the interior of the appliance. The irrigation system utilizes an electrical aquatic pump that continually cycles nutrients to plants and aquatic life within the appliance. The irrigation system includes a seed incubator that is inundated with purified water generated by the atmospheric condenser and from excess water collected by an errant drip siphon. A digitally functioning visual monitoring and sound transmittance device allows the appliance to be operated from anywhere in the world that can receive an internet signal. The appliance contains a motorized rotary carousel that raises each growing tray to a specific height for irrigation and a lower height for ergonomic purposes. All of the electrically powered functions of the appliance can be controlled manually or through remote access of a mobile device.

### BACKGROUND

Agricultural practices have traditionally involved using massive tracts of land to raise animals and cultivate plant crops in order to provide sustenance for growing populations. Methods of agriculture have evolved to increase plant and animal production. With these increases in food production have come exponential increases in the human population such that the traditional methods of agriculture will eventually become obsolete. Modern advances in agricultural methods have resulted in providing indoor, controlled environments for plants and animals. Avant-garde agricultural practitioners typically choose locations within or close to urban areas. Urban farming usually consists of vertically oriented hydroponic operations setup within warehouses, shipping containers, greenhouses, vacant lots or rooftops. As urban farming begins to create a larger niche market, advances in its methods of production will need to become more efficient in order for growers to scale up operations. Although more efficient than traditional field farming, urban farming currently faces challenges that involve start up costs, scale up costs, ergonomics, space management, time management, energy consumption and labor.

### FIELD OF THE INVENTION

The present invention relates to agricultural appliances, processes for growing plants, farming aquatic animals, bee keeping and raising poultry in urban, rural and suburban settings. Specifically, this invention is directed to an Integrated Mobile Aquaponic System or [IMA] System that can be operated in variety of environmental conditions, building types and geographic locations.

### DESCRIPTION OF RELATED ART

The current state of the art is in its infancy. To date, participants in the aquaculture industry have developed an array of procedures, devices and tools that seek to improve methods of production, investment cost, overall work time, energy consumption and usage of space.

There are four major categories of production that aquaculture is practiced within; rooftop garden, greenhouse, warehouse and shipping container means of production. The greenhouse method of aquaculture FIG. 25, converts the interior of a traditional greenhouse into a series of exposed, above ground irrigation systems that feed water and nutrients to plants and/or aquatic creatures. The greenhouse method, like traditional field farming, maintains a horizontal datum but is distinguished by its use of a translucent enclosure that protects plants and aquatic life from the external environment while still providing natural light.

The warehouse method of production FIG. 26, FIG. 29, usually takes place in a large, renovated space that seeks to take advantage of high ceilings by stacking planting trays vertically on engineered shelves. These operations contain vast irrigation systems that provide water and nutrients to the planting trays. Unlike the greenhouse, the typical warehouse method provides no natural light. This lack of natural light is supplemented by artificial, low cost lighting situated directly above each growing shelf Due to the height of each shelf, warehouses must use devices that lift workers to each level for inspection and harvesting of crops.

The shipping container method FIG. 27a, FIG. 28, of production functions within a metal, cargo-shipping unit. The unit has two floor to ceiling doors at one end that serve as the entrance and exit. Shipping containers are usually delivered by truck prefabricated with irrigation systems, electrical runs, insulation and ventilation systems that aid in hydroponic plant growth. The typical shipping container uses artificial lighting that may have various configurations and operate along a narrow corridor provided by two rows of planting space.

The rooftop gardening method FIG. 25, seeks to utilize space that would otherwise be vacant by raising the traditional greenhouse to a higher datum within an urban context. The efficiency of the rooftop garden relies on the users ability to travel back and forth to the street level from the roof. The number of stories in the building being used plays a big factor in the ergonomics of the operation. For commercial applications, an architect or engineer may need to be consulted if no elevator exists in the building. This can delay a project's timeline; drive startup cost beyond budget and delay delivery schedules. Without an efficient means to access the street level from the roof, users are faced with hauling equipment and produce up and down many flights of narrow stairs therefore draining energy from the most important aspects of the operation.

Rooftops, greenhouses, warehouses and shipping containers are stationary, sheltered and artificially controlled means of agricultural production but do not maximize the most efficient methods of production, space used, time invested and energy consumed per application. The original use and design intention of each aforementioned space places restrictions on its final converted use.

Currently, the state of the art of commercial-level aquaculture is struggling with fragmented, experimental methods of agricultural production. The majority of practitioners of the art, due to the lack of an integrated appliance, are faced with issues regarding acquiring equipment from various sources, time investment, securing financial resources and the inability to scale-up production due to initial startup cost.

Practitioners of the art which include architects, engineers, agricultural experts, scientists and the businesses they supply have seen massive failures involving commercial production for large and small-scale operations due to lack of industry innovation and research.

The present invention seeks to address all of the major design issues FIG. 25a, FIG. 26a, FIG. 27, FIG. 28a, FIG. 29a that will eventually act as progress inhibitors for the art.

### BRIEF SUMMARY OF THE INVENTION

This disclosure provides a digital, self-sustaining, integrated, semi automated, remote-controllable mobile aquaponic appliance. Alternate uses of one or a combination of elements of the device may be apparent to one skilled in the art.

In a first embodiment, the appliance includes at least one photovoltaic panel that supplies power to a solar battery. The solar battery supplies power to a device that generates purified water and controls the temperature and all other electrical functions within the appliance.

In a second embodiment, the appliance includes at least one seed incubation compartment.

In a third embodiment, the appliance includes at least one vertically oriented, gear chain or rubber belt driven, motorized, tray-rotating carousel that eliminates the need for a lift device or ladder for user access. This embodiment has an optional source of power independent of internal or external sources of electricity.

In a fourth embodiment, the appliance includes at least one detachable remote control chassis that houses all the components belonging to the rolling members. This embodiment has an optional source of power independent of internal or external sources of electricity.

In a fifth embodiment, the appliance includes at least one PH control system.

In a sixth embodiment, the appliance includes at least one plant nutrient delivery system.

In a seventh embodiment, the appliance includes at least one rainwater catchment surface.

In an eighth embodiment, the appliance includes at least one power plug to draw electricity from external sources of power.

In a ninth embodiment, the appliance includes at least one solar battery. The solar battery supplies power to an electrical wiring system that generates purified water and controls the temperature and all other electrical functions within the appliance.

In a tenth embodiment, the appliance includes at least one poultry cage enclosure that doubles as can also be use as an observation beehive for pollen collection and honey production.

In an eleventh embodiment, the appliance includes at least one irrigation pump that delivers water and nutrients to each growing tray that rotates to the top of the appliance.

In a twelfth embodiment, the appliance includes an aquatic-grade tank for the purpose of farming fish and other water-dwelling creatures.

In a thirteenth embodiment, the appliance includes at least one lower shelf for the purpose of storing seedling trays, holding at least one aquatic-grade tank, growing a plurality of vegetables/fruits and returning cyclical water back through the irrigation system.

In a fourteenth embodiment, the appliance includes at least one vertically or horizontally oriented configuration that emits artificial light from the narrow space in between the rotating growing shelves. This embodiment has an optional source of power independent of internal or external sources of electricity.

In a fifteenth embodiment, the appliance includes a plurality of porous, translucent covering panels designed to ventilate and protect the plants and animals within the appliance from disease and pests.

In a sixteenth embodiment, the appliance includes at least one digital visual monitoring device with remote access that can be used to steer the appliance in multiple directions and monitor growing activity within the appliance.

In a seventeenth embodiment, the appliance includes at least one x,y-axis semi-automated mechanical appendage that injects seeds into various growing mediums and harvests mature plants.

In an eighteenth embodiment, the appliance includes at least one semi-automated, motorized x,y-axis bearing track rail that allows simultaneous vertical and horizontal movement of at least one digital visual monitoring device that works in tandem with a least one moving mechanical appendage.

In a nineteenth embodiment, the appliance includes at least one retractable electric component that acts as a power source derived from power stored in the solar battery or some other external power source such as a generator or municipal electrical power wall outlet.

In a twentieth embodiment, the appliance includes a plurality of temperature-activated fans for the purpose of lowering temperature, eliminating humidity and evaporating moisture within the appliance.

In a twenty-first embodiment, the appliance includes at least one errant drip scupper that siphons excess growing tray water at missed rotation intervals back into the irrigation system.

In a twenty-second embodiment, the s appliance includes at least one rotating carousel gear access cover.

In a twenty-third embodiment, the appliance includes a plurality of unique growing trays that equally distribute nutrient rich irrigation water to a plurality of plants.

In a twenty-fourth embodiment, the appliance includes a plurality of tubes that deliver irrigation water drained a plurality of rotating growing trays to a plurality of rotating growing trays below a plurality of rotating growing trays.

In a twenty-fifth embodiment, the appliance includes a plurality of locking/unlocking mechanisms that allow the top portion of the appliance to attach and detach from the bottom portion of the appliance.

### BRIEF DESCRIPTION OF THE DRAWINGS

FIG. 1 illustrates a view of the major exterior elements of the appliance. It displays variations of components of the appliance that could be of potential use.

FIG. 2, FIG. 3 and FIG. 4 illustrate the basic front/back left and right elevation views of the appliance. Some interior mechanical elements have been omitted in order to provide visual clarity.

FIG. 8, FIG. 9 and FIG. 10 illustrate the function of the automated mechanical appendage, the multiple uses of the lower tiers of the appliance and finally the ability of the appliance to move according to space requirements.

FIG. 5, FIG. 6 and FIG. 7 illustrate the ability of the mechanical appendage and the digital monitoring device's ability to move vertically and horizontally on the fixed, motorized bearing track and how the detachable translucent cover panels are affixed to the appliance.

FIG. 11 and FIG. 12 illustrates the ability of the appliance to detach the upper portion and lower portions which provide the user with the option of moving the appliance through smaller doorways unassembled and through larger doorways fully assembled.

FIG. 13 and FIG. 14 illustrate the porous, translucent cover panel that contains interior rows designated for seedling propagation. FIG. 14 also illustrates the retractable stand that allows the user to examine the seedlings in their early stages before transplanting to the appliance's growing trays.

FIG. 15 illustrates an example of the function of each seedling propagation row located on the interior of the translucent cover panel.

FIG. 16 illustrates the user's ability to monitor and control specific functions of the appliance through a cell phone application.

FIG. 17 and FIG. 18 illustrate the user's option to use the appliance indoors or outdoors. This drawing also illustrates a water flow diagram of the irrigation system as it relates to indoor and outdoor usage.

FIG. 19 illustrates the flexibility of the appliance as it pertains to monitoring and controlling the appliance from remote locations internationally that essentially creates farms without international borders.

FIG. 20, FIG. 21, FIG. 22, FIG. 23 and FIG. 24 illustrate the fundamental mechanisms driving the ergonomic value harnessed by the appliance.

FIG. 25 and FIG. 25a illustrates a comparison of total unused growing space in relation to the appliance versus the traditional hydroponic greenhouse model.

FIG. 26 and FIG. 26a illustrate a comparison of total unused growing space in relation to the appliance versus the traditional hydroponic warehouse model.

FIG. 27 and FIG. 27a illustrate a comparison of the present appliance's flexible arrangements of user workflow versus the traditional shipping container method of restricted user movement and work area.

FIG. 28 and FIG. 28a illustrate a comparison of appliance versus the traditional shipping container model. The appliance has the ability to generate greater product output while using less space than the traditional shipping container model.

FIG. 29 and FIG. 29a illustrate a comparison of the appliance versus the traditional warehouse model The present unit simplifies user workflow by providing easy, safe access to two users that maximizes the efficiency of large and small-scale operations.

### SUMMARY

The use of an agricultural appliance that is mobile, ergonomic and digital, will create a production capacity in the farming industry that has not yet been attained.

To address current issues in ergonomics, one embodiment of the appliance contains a rotary carousel which gives the user eye-level access to any given growing tray for harvesting or inspection. This feature ensures that the user does not compromise personal safety on tall ladders and mechanical lifts during work activities.

Another embodiment includes rolling members attached to the appliance. These semi-automated rolling members allow the appliance to adapt to almost any space such that the maximum amount of appliances can be used in one space therefore increasing growing output. Fixed growing shelves prevent operations from scaling up and cannot be transport to other locations if required.

Additional components, advantages and properties of the appliance according to this application will be realized in the detailed description.

### DETAILED DESCRIPTION AND BEST MODE OF IMPLEMENTATION

The following description accompanied by its numerous embodiments, utilize illustrations presented in a way that are not intended to place limitations on the extent of the description or the functions of the appliance. The illustrations contain a mixture of measurements to communicate scale but for the purposes of this description's format requirements are not actually to scale. It is important to note that the present description of the embodiments should not be limited to the exact representation in the illustrations and that the appliance could be realized by a myriad of methods of assembly and functions. The drawings are intended to exhibit the fundamental attributes of the appliance and how those attributes interact with each other.

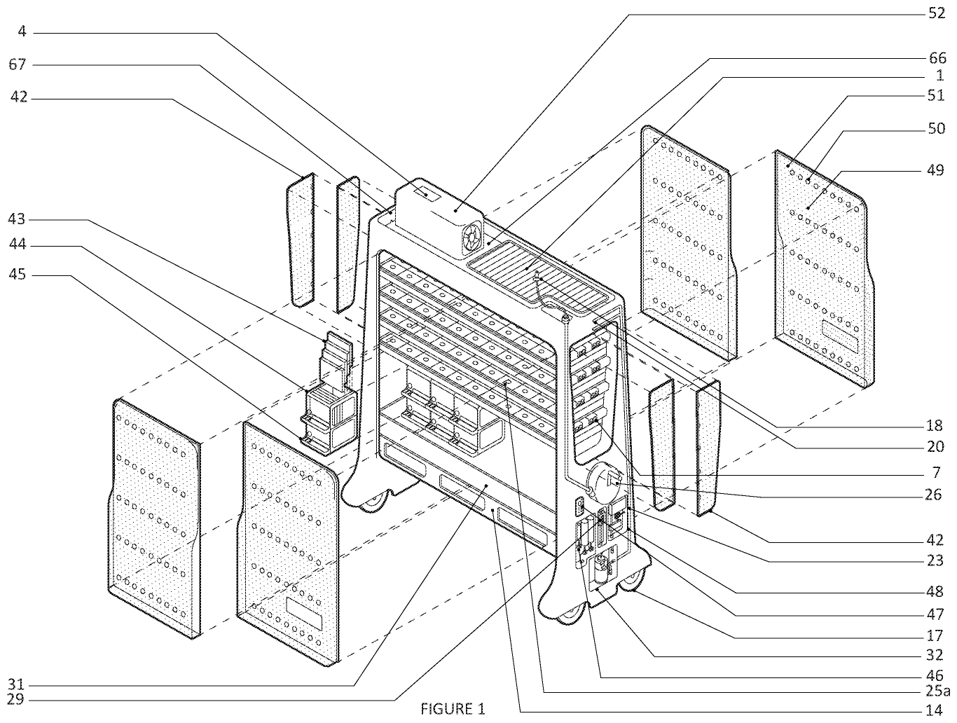

The following description pertains to all of the appliance's elements illustrated in FIG. 1. FIG. 1 illustrates a semi exploded, isometric view of a plurality of appliance's external components. The appliance includes at least one photovoltaic panel 1, that supplies electrical power to all electrical components 1, 4, 18, 32, 47, 46, 29, 48, 7, 52, within the appliance through an electrical wiring system. The photovoltaic panel 1 also supplies power to electrical components not shown in FIG. 1. At least one atmospheric condenser 52, generates water from humidity in the surrounding air then pumps the potable water to a water purification unit 4. The purified water is then circulated throughout the entire irrigation system 20, 31, 46, 32, 48, of the appliance and other irrigation components not shown in the illustration FIG. 1. At least one rainwater collection surface 66, is used for outdoor applications and also supplies potable water to the appliance's entire irrigation system 20, 31, 46, 32, 48, by way of a plurality of drainage openings 67, situated at the top of the appliance. At least one retractable power cord 18, can be used as a primary or secondary source of electrical power for the all of the electrical components within the appliance 1, 4, 18, 32, 47, 46, 29, 48, 7, 52. Pluralities of translucent, porous cover panels 51, 42, are used to cover the openings of the appliance for use of during outdoor applications. The front and back translucent cover panels 51, have a plurality of small, prefabricated openings through the surface that allow the appliance's interior to ventilate accumulated humidity and heat within the appliance. A plurality of automated temperature activated oscillating or stationary fans 7, serve as cooling mechanisms for the appliance's interior such that mold and moisture are eliminated. Pluralities of maintenance access panels 26, 42, are embedded in the frame of the appliance such that they provide access to the appliance's carousel rotary gears and retractable electric cord 18. At least one compartment embedded within the frame of the appliance exists for the purpose of housing a remote control 47, for the purpose of steering the appliance's plurality of rolling members 17 and operating all other electrical components 1, 4, 18, 32, 47, 46, 29, 48, 7, 52, pertaining to the appliance. At least one automated nutrient delivery system 46, exists for the purpose of providing plants with appropriate sustenance by way of an irrigation system 23. At least one automated PH controller 48, exists for the purpose of stabilizing the alkaline and acidic properties of the water within the irrigation system 23, of the appliance. At least one compartment housing at least one irrigation pump 32, is embedded within the frame of the appliance for the purpose of supplying liquid nutrients 46, purified water 4, potable water 66, and PH solution 23, 46, to the plants within a plurality of growing trays 25a, within the appliance. A plurality of removable dual-purpose enclosures 44, provide artificial observation hives for beekeeping such that the plurality of enclosures 44, provides an environment for the purpose of pollen collection and honey production. Pluralities of removable dual-purpose enclosures 44, are fabricated such that their contents 43, are observable by means of various transparent materials. In another embodiment of the appliance, a plurality of removable dual-purpose enclosures has an tray attachment 45, for the purpose of providing farm foul with fresh water, feed pellets and a layer hen egg catchment gutter. Pluralities of automated and manually operated rotating plant growing trays 25a, exist such that plants are provided with equal amounts of water, natural/artificial light and ventilation. FIG. 1 also illustrates at least one aquatic-grade tank 31, for the purpose raising a plurality of aquatic animals. The water from this aquatic-grade tank 31, acts as an additional source of nutrients to the plants by cycling ammonium and nitrites from fish waste through the irrigation system 48, which is absorbed by a plurality of plants within the appliance. The appliance has at least one permanent irrigation return tray 14, for the purpose of channeling water to stationary potted plants and back through a plurality of drain openings, which lead to the device's irrigation pump 32.

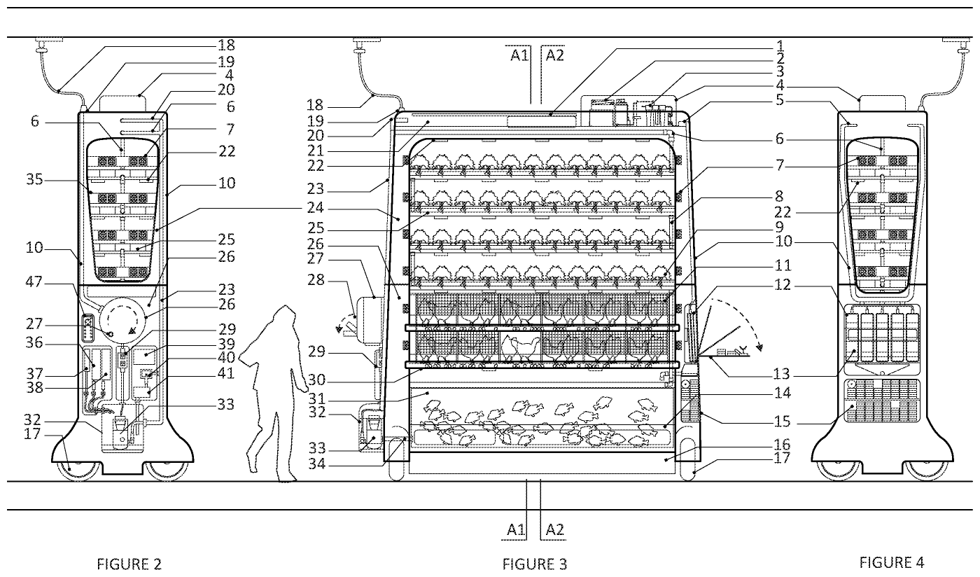

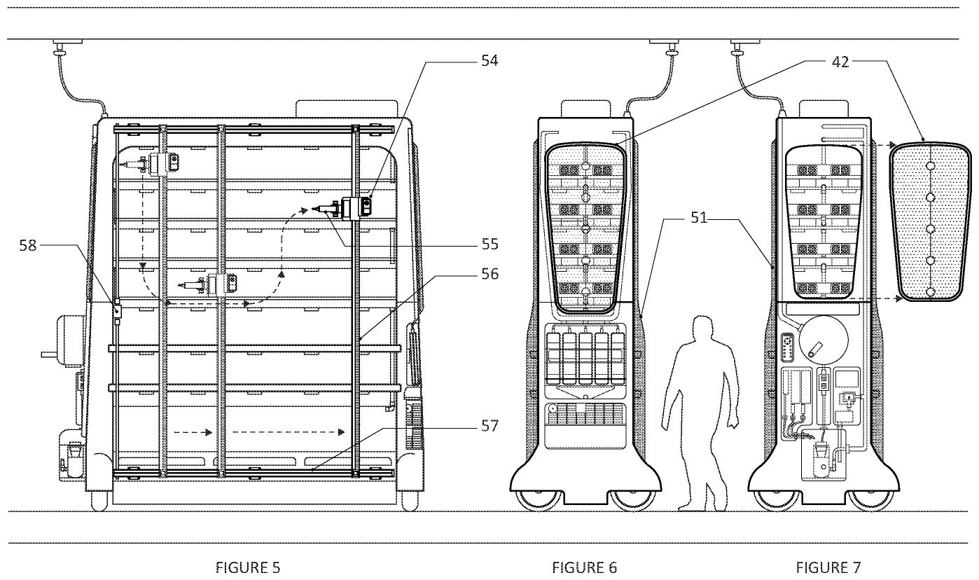

The following description pertains to all of the appliance's elements illustrated in FIG. 2 which were not communicated in FIG. 1. FIG. 2 illustrates at least one primary spout for irrigation water 6, 21, for the purpose of providing nutrients to plants stored within rotating growing trays 25a. At least one irrigation pump 33, which supplies water to the entire irrigation system. At least one set of nutrient delivery capsules 36, 38, which supply plants with liquid-based sustenance throughout the appliance's irrigation system. The appliance contains at least two points of separation wherein the top of the appliance 24, can be detached from the bottom of the appliance 26.

The frame of the appliance 24, 26, can be fabricated by thermoforming or vacuum forming carbon fiber, fiberglass, polycarbonate, plastic or plexiglass from industrial mold-making processes. The frame of the appliance 24, 26, can be fabricated by using advanced carpentry practices by CNC milling laminated wood or other wood-related products. The frame of the appliance 24, 26, can be fabricated by cold/hot forming stainless steel or copper from sheet metal.

The following description pertains to all of the appliance's elements illustrated in FIG. 3 and FIG. 4. These illustrations contain at least one water purification unit 3, that filters water generated by at least one atmospheric condenser 2, that are both housed by a cover 4, fabricated of a translucent material. The purified water is cycled into the irrigation system by traveling through an irrigation shaft 10, 23, embedded in the frame of the appliance. The purified water then fills a plurality of sponge-filled detachable seedling propagation compartments 12, which can be examined on the surface of the fold-down sprout examination tray 13. The temperature of the seedling incubation chamber can be adjusted by at least one artificial lighting source 22, which also serves as a heat source. This chamber 12, is ventilated by a temperature-activated fan 7, which eliminates humidity and moisture accumulation. Another compartment 15, embedded within the frame of the appliance acts as storage for a plurality of growing mediums and houses at least one solar battery. At least one hand-held remote 47, controls the appliance's rolling members 17, and chassis 16, and can be driven forward, backward, pivot left and pivot right but are not limited to the stated range of motion.

The following descriptions pertain to all of the appliance's elements illustrated in FIG. 5, FIG. 6 and FIG. 7. FIG. 5 illustrates a digital, remotely operated visual monitoring device 54, that allows the user to have remote visual access to a plurality of plants growing, at least one aquatic-grade tank, a plurality of portable dual-purpose enclosures and various other parts of the appliance. The remote visual access device 54, contains a built-in viewing screen and a sound transmittance device that enables two users to communicate remotely with each other via internet or from device to device within close proximity. FIG. 5 also illustrates at least one remotely operated mechanical appendage 55, which can deposit seeds into various growing mediums and harvest plants within the appliance. Each element 54, 55, is mounted to a motorized bearing track 56, 57, which is automated or manually operated to function on an x,y-axis. The user can also use the remote visual access device 54, to steer the appliance forward, backward, pivot left and pivot right. FIG. 6 and FIG. 7 illustrate a plurality of removable translucent cover panels 42, 51, which provide access to various interior portions of the appliance.

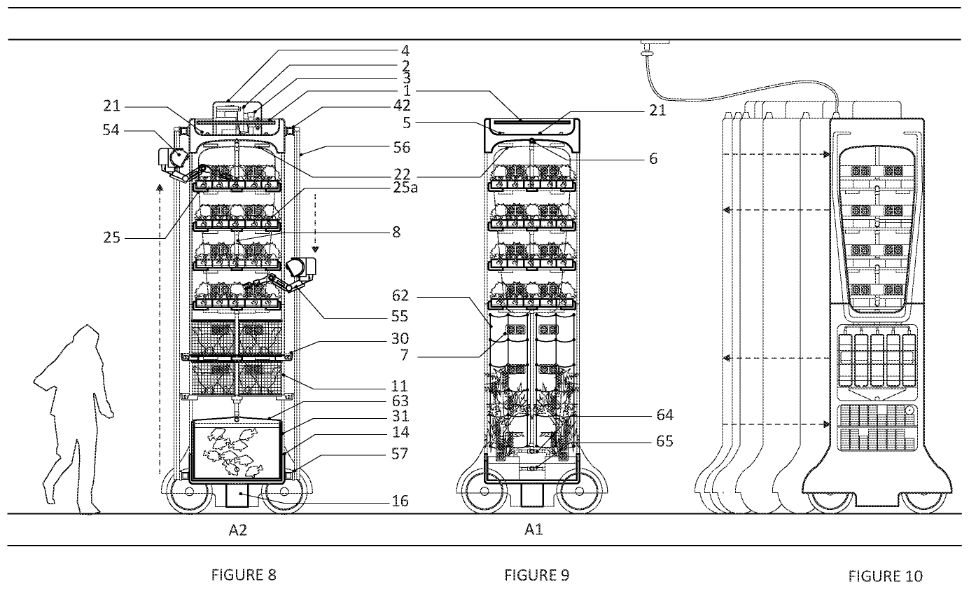

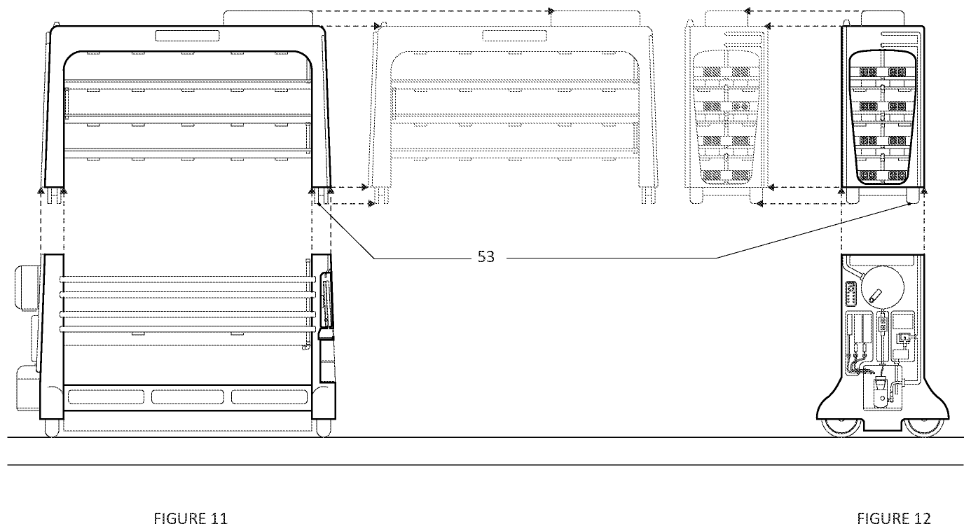

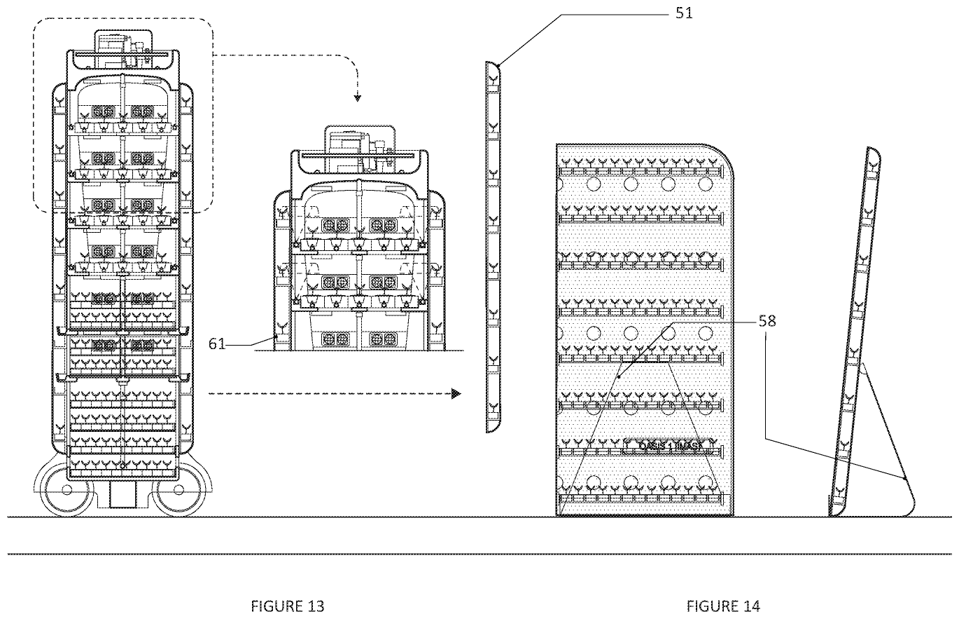

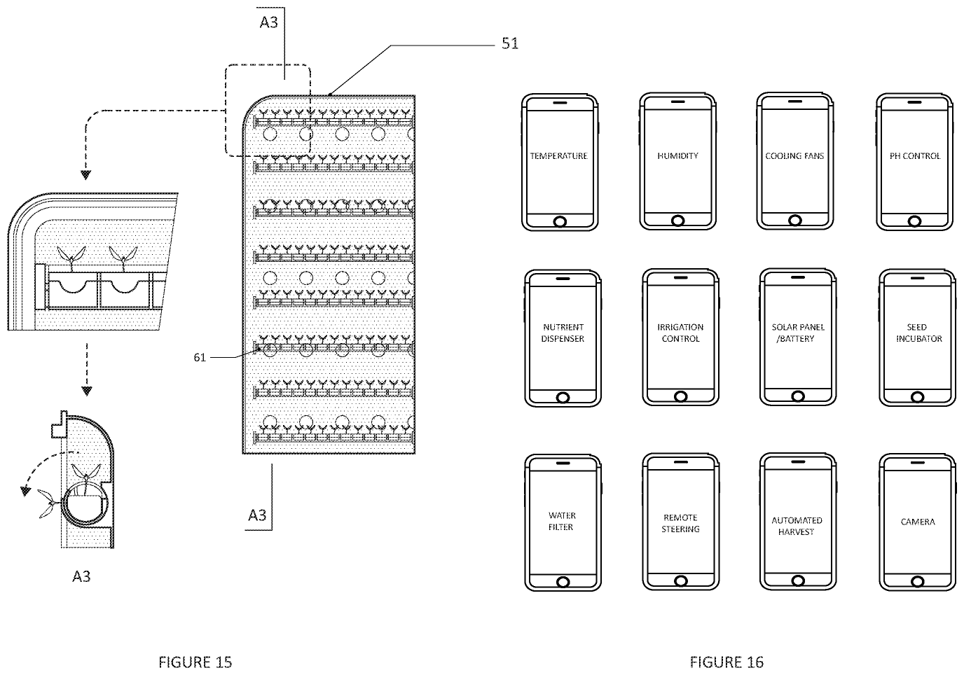

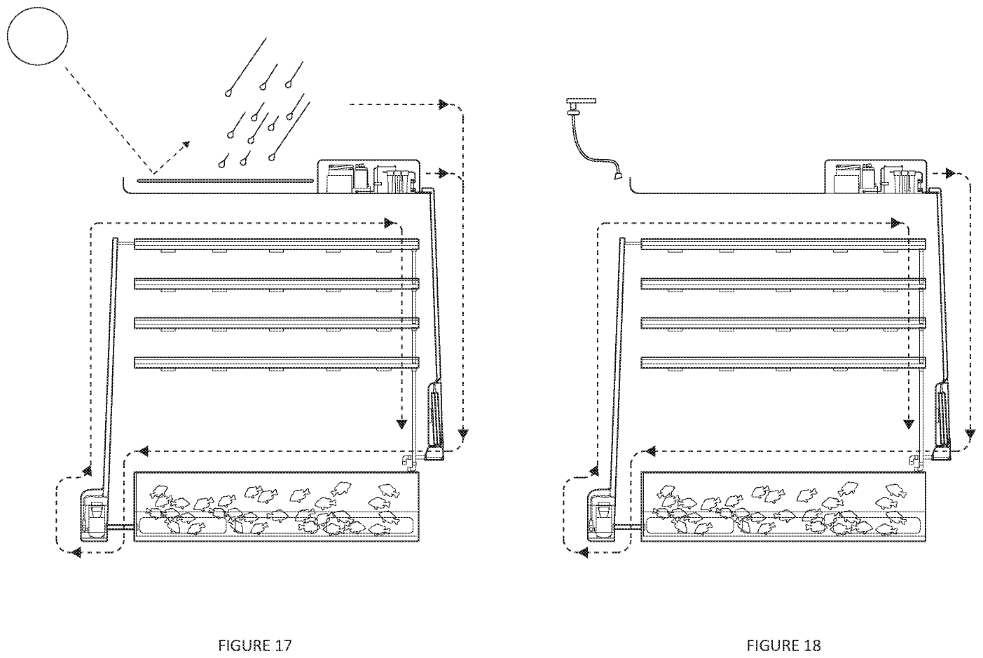

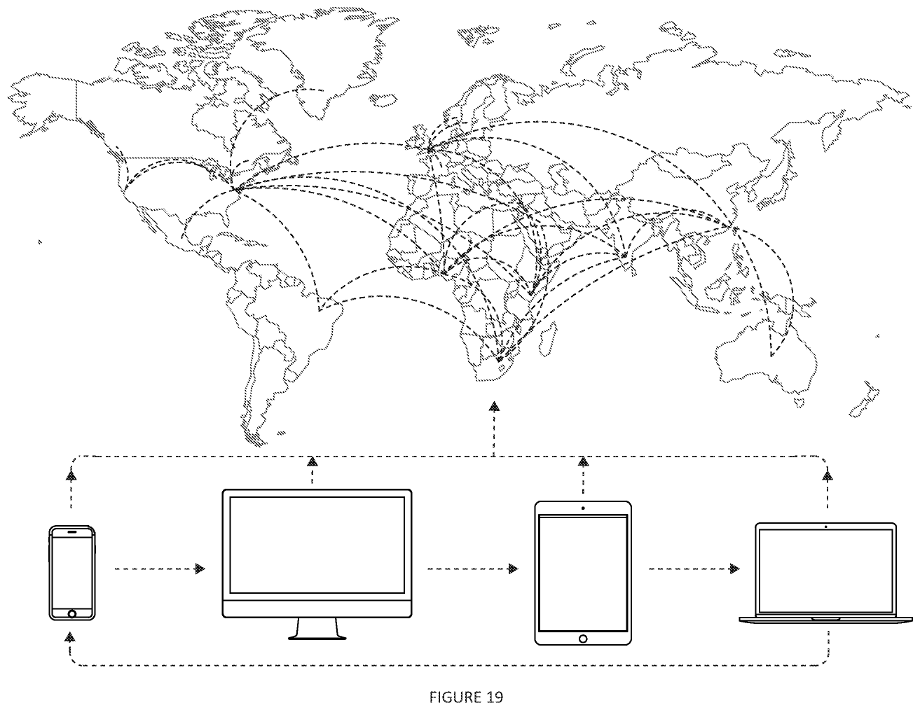

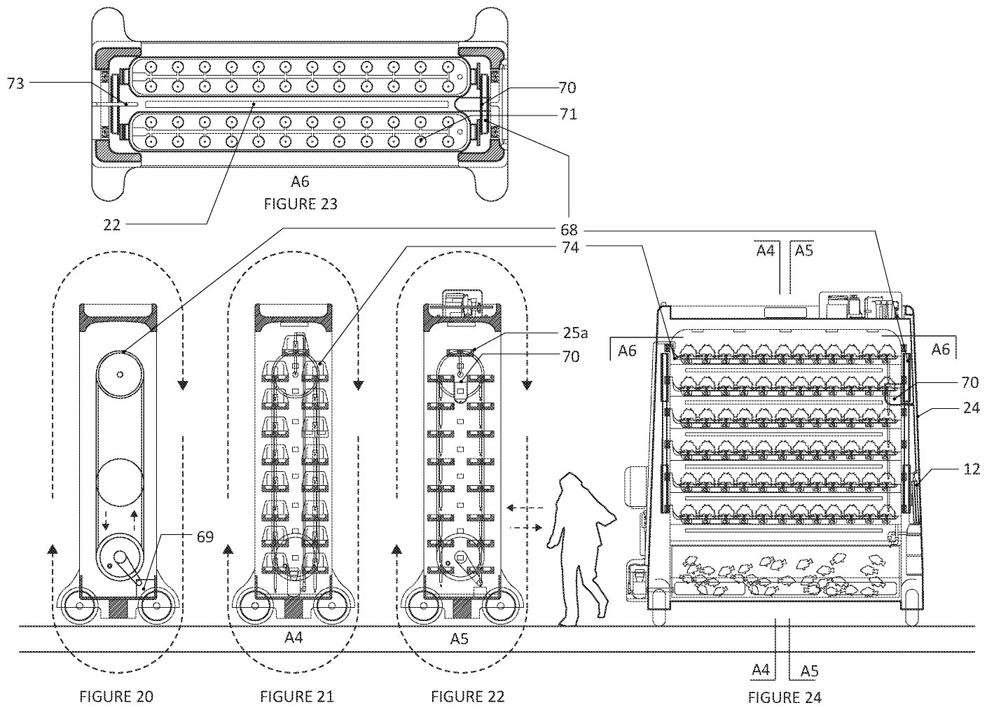

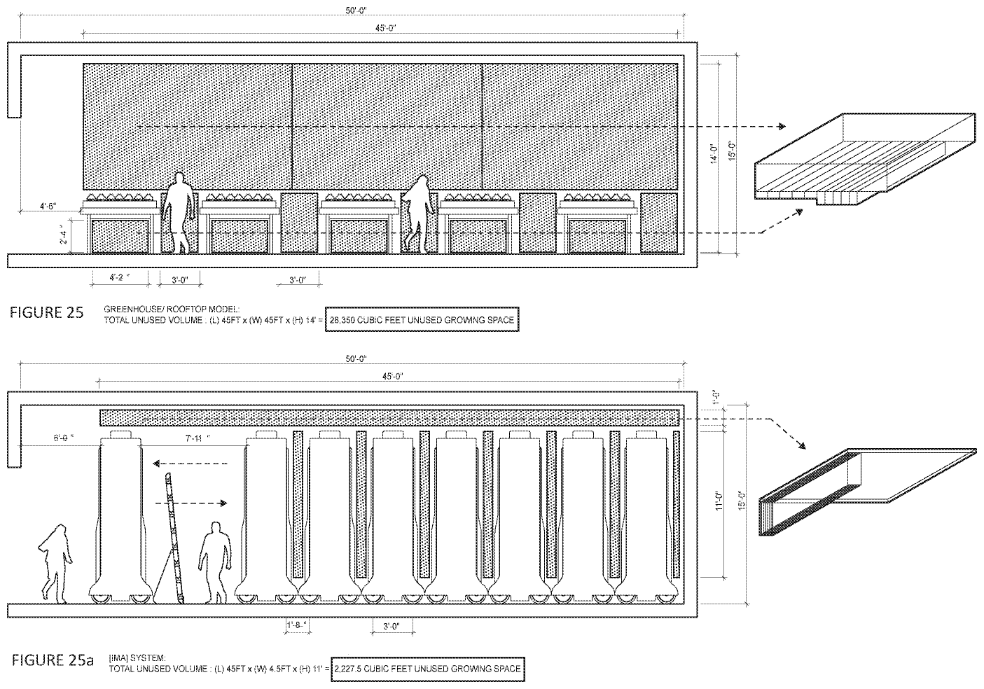

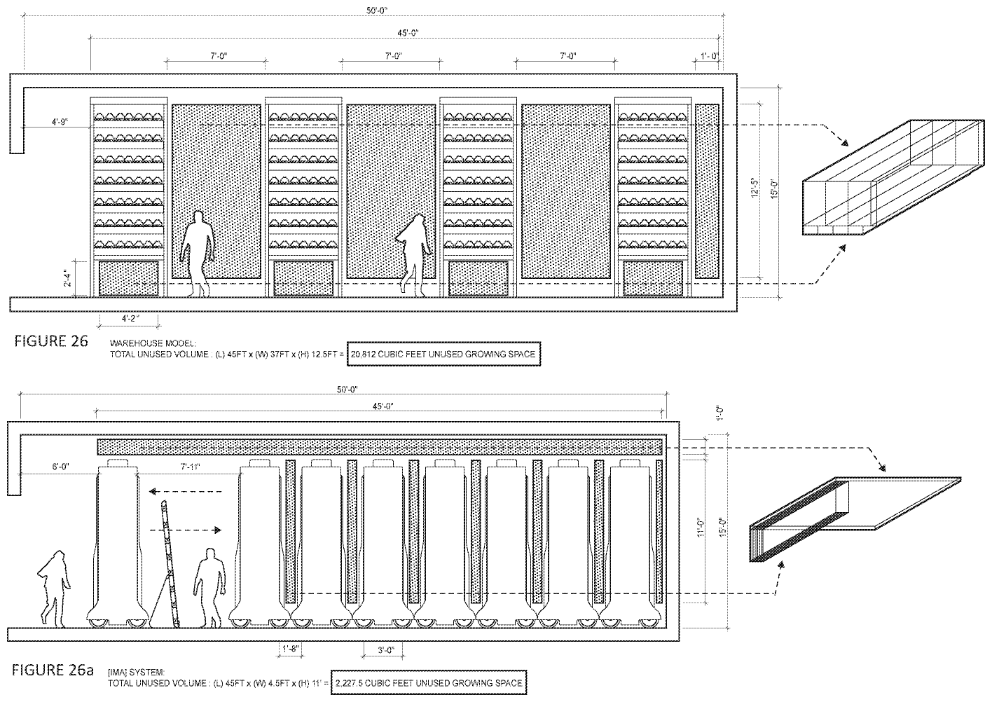

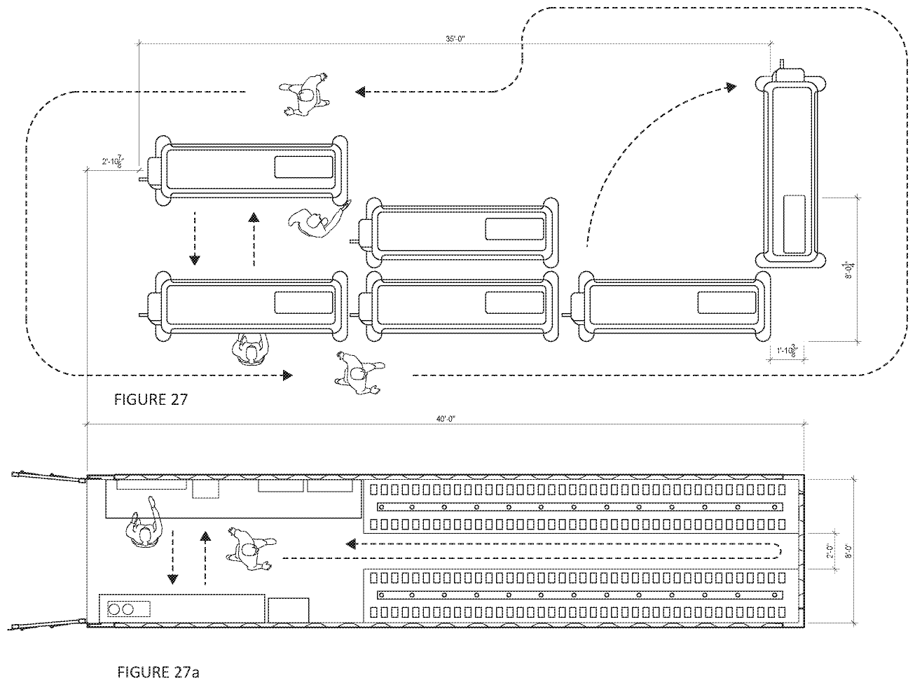

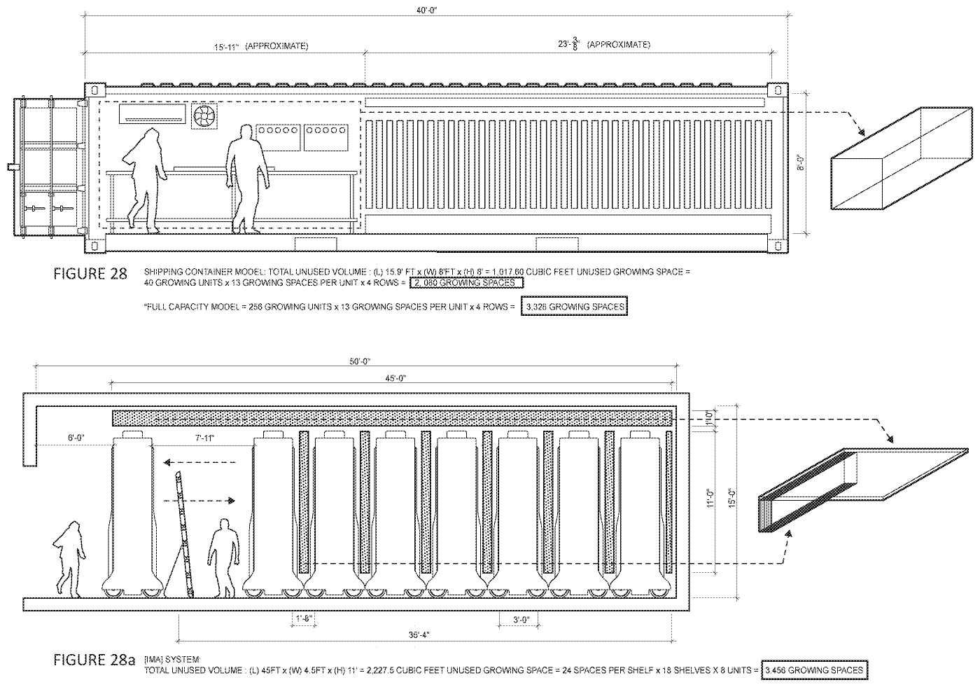

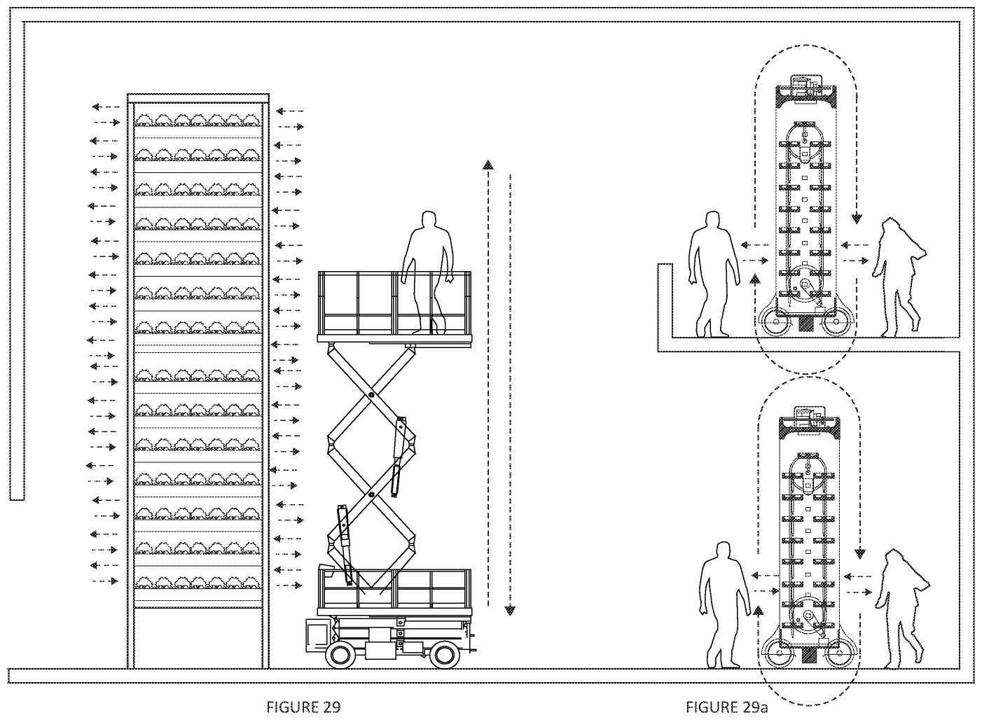

The following descriptions pertain to all of the appliance's elements illustrated in FIG. 8, FIG. 9 and FIG. 10. FIG. 8 reiterates the illustration from FIG. 5 by displaying the vertical capabilities of the mechanical appendage 55, and the digital remote visual access device 54. The chassis 16, which houses the rolling members has the ability to detach from the rest of the appliance for the purpose of ease of transport through narrow openings. FIG. 9 illustrates the appliance's plant vine trellis system 62, used to provide support for developing potted plant stem structures and hanging fruits/vegetables. At least one irrigation water supply pipe 64 and at least one irrigation return pipe 65, provides the appliance with a complete cycle of water that can be continually used to reduce water consumption. FIG. 10 illustrates the back and forth movement of the appliance.

The following descriptions pertain to all of the appliance's elements illustrated in FIG. 11 and FIG. 12. Both figures illustrate a locking mechanism 53, embedded within the frame of the appliance that allow the top of the appliance to be separated from the bottom. This adaptation of form ensures that the appliance can be transported, stored and operated comfortably within any outdoor or indoor environment. The device's ability to disassemble will allow a broader range of demographic access to the agricultural industry.

The following descriptions pertain to all of the appliance's elements illustrated in FIG. 13 and FIG. 14. FIG. 13 illustrates the plurality of translucent cover panels 51, and their ability to attach and detach to the frame of the appliance. A plurality of rotating seedling propagation sockets 61, are situated in a plurality of rows within the translucent cover panel 51, such that each socket receives natural/artificial light, ventilation and access to manual watering. FIG. 14 illustrates at least one integrated retractable stand 58, which gives the user the ability to inspect sprouted plants, manually propagate new seedlings within growing mediums and water sprouted seedlings in preparation for transition to the rotating growing trays 25a. The translucent cover panel 51, is essentially a space-saving element for indoor and outdoor applications.

The following descriptions pertain to all of the appliance's elements illustrated in FIG. 15 and FIG. 16. FIG. 15 illustrates the ability of the seedling propagation sockets 61, to rotate to an upright position when the translucent cover panel 51, is oriented horizontally. Each end of the rotating propagation socket row 61, contains a knob such that the user can rotate each row with a thumb and pointer finger. FIG. 16 illustrates all of the remote features available to the user that allow monitoring and remote control of the appliance's main functions.

The following descriptions pertain to all of the appliance's elements illustrated in FIG. 17 and FIG. 18. FIG. 17 and FIG. 18 illustrate the appliance's potential power sources and cycle of water irrigation. FIG. 17 illustrates the solar powered outdoor application. FIG. 18 illustrates the typical electric outlet powered indoor application.

The following descriptions pertain to all of the appliance's elements illustrated in FIG. 19. FIG. 19 illustrates a network of mobile devices that interact for the purpose of creating a worldwide borderless agricultural environment in which skilled and unskilled labor can be employed and managed remotely.

The following descriptions pertain to all of the appliance's elements illustrated in FIG. 20, FIG. 21, FIG. 22, FIG. 23 and FIG. 24. FIG. 20, FIG. 21, FIG. 22, illustrates an adjustable rotating mechanism 68, comprising an endless gear that is powered by an electric motor 69, at the base of the appliance. The rotating mechanism 68 raises and lowers each growing tray 25a to a maximum height where a plurality of plants receive a specified amount of water per growing tray 25a. FIG. 23 illustrates the unique irrigation design that allows nutrient-rich water to permeate each growing socket 71, and the narrow space between growing trays 25a that provides room for artificial lighting 22. FIG. 23 also illustrates at least one irrigation spout 73, which delivers water down the hydrodynamic incline 74, of the growing tray 25a. As the plurality of growing trays 25a, rotate, errant water may drip between the adjacent pluralities of trays. This excess water is caught by the errant drip scupper 70, and funneled down to at least one seed incubation chamber 12, embedded into the frame of the appliance 24. FIG. 24 illustrates a plurality of rotating mechanisms 68, which are responsible for lifting a plurality of growing trays 25a.

1. A multi-layered, mobile aquaponic appliance, comprising:
a plurality of manual or automated rotating irrigation shelves which contain a plurality of rows of a plurality of growing compartments per irrigation shelf such that a maximum number of plants grown per cubic foot is achieved.

2-20. (canceled)
